(19) United States
(12) Patent Application Publication
(10) Pub. No.: US 2008/0077758 A1
(43) Pub. Date: Mar. 27, 2008

(54) Virtual tape device and data management method for virtual tape device

(75) Inventor: Tatsuya Ohmido, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/723,157

(22) Filed: Mar. 16, 2007

(30) Foreign Application Priority Data
Sep. 22, 2006 (JP) 2006-258040

(51) Int. Cl. G06F 12/12

(52) U.S. Cl. 711/162

(57) ABSTRACT

A virtual tape device is interposed between a host system and a tape library device to store data transmitted and received between the host system and the tape library device as a virtual tape volume. The virtual tape device includes a storage device for storing the data sent from the host system as the virtual tape volume, save start means for starting to save the data in the tape library device upon completion of the storage of the data as the virtual tape volume, and deleting means for deleting from the storage device the virtual tape volume corresponding to the saving upon completion of the saving.

### BACKGROUND OF THE INVENTION

1. Field of the Invention

The present invention relates to a virtual tape device used as a cache of a tape library device connected to a host system, and a data management method for a virtual tape device.

2. Description of the Related Art

Conventionally, to back up data of a storage device connected to a host system, a computer system uses a magnetic tape library device containing a plurality of magnetic tapes. The backup operation is performed at night in many cases. If the amount of data to be backed up is increased, however, the time required for the backup operation is also increased due to the slow access speed of the magnetic tapes. As a result, there arises a situation in which the backup operation interferes with regular daytime operations. In light of this circumstance, there has recently been developed a virtual tape device that uses, in place of the tape library device, a disk device accessible at a higher speed than the tape library device. The virtual tape device virtually emulates the tape library device on the disk device included in a disk system connected to the host system. Therefore, the virtual tape device can access a storage medium at a higher speed than the real tape library device. That is, with virtual tape volumes mounted on the disk device, the virtual tape device omits mechanical operations of the conventional tape library device, such as tape mounting and loading/unloading, to thereby achieve high-speed processing. Further, according to the virtual tape device, the tape library device is connected to a back-end system, and the tape volumes are collectively written on a high-capacity cartridge tape of the tape library device connected to the back-end system. Usually, a RAID (Redundant Array of Independent Disk) device is used as a device for emulating the tape library device. The RAID device serves as a TVC (Tape Volume Cache). The tape volumes to be emulated are all placed in the tape volume cache. When the tape volume cache runs out of free space, the least recently accessed tape volume is saved in the tape library device and deleted from the tape volume cache. To use the deleted tape volume, the tape volume is read from the tape library device connected to the back-end system and is placed on the tape volume cache (Japanese Unexamined Patent Application Publication No. 2005-537555).

Although a mainframe computer uses a magnetic tape device for inputting and outputting data in a batch operation or the like in some cases, the tape volumes are placed on the tape volume cache, and thus the high-speed processing can be performed. However, backup data of the backup operation is not used in regular operations. If such data remains on the tape volume cache in every backup operation and thus the disk runs out of free space, the tape volumes are deleted in the order of access from the least recently accessed one. In the virtual tape device, to use the tape volume once deleted from the tape volume cache, it is after the tape volume has been read from the tape library device of the back-end system and restored on the tape volume cache that the tape volume becomes usable. Thus, the access time to the tape volume becomes significantly longer than the access time to a tape volume on the tape volume cache. As described above, if the backup operation is performed frequently, the backup data not used in the regular operations remains on the tape volume cache. Therefore, there arises a case in which, if a tape volume used in the batch operation is deleted from the tape volume cache, for example, the access time to the tape volume is prolonged and thus the batch operation takes a long time. As a result, the high-speed processing, which is an original advantage of the virtual tape device, is deteriorated in some cases.

### SUMMARY OF THE INVENTION

The invention according to the present application provides a virtual tape device interposed between a host system and a tape library device to store data transmitted and received between the host system and the tape library device as a virtual tape volume. The virtual tape device is configured to include a storage device for storing the data sent from the host system as the virtual tape volume, save start means for starting to save the data in the tape library device upon completion of the storage of the data as the virtual tape volume, and deleting means for deleting from the storage device the virtual tape volume corresponding to the saving upon completion of the saving. According to the configuration, the data sent from the host system is immediately output to the tape library device upon completion of the storage of the data in the storage device of the virtual tape device. Therefore, unnecessary data does not remain on the storage device. As a result, removal of data for a batch operation from the storage device is suppressed.

In this manner, a tape volume of backup data unnecessary for regular operations is prevented from remaining on a tape volume cache, with no need for an application change. Thereby, a tape volume used in input and output operations remains on the tape volume cache, and thus the tape volume cache can be effectively used. Further, the capacity of the tape volume cache can be reduced by the effective use of the tape volume cache.

### BRIEF DESCRIPTION OF THE DRAWINGS

FIG. 1 is a configuration diagram of a virtual tape device;

FIG. 2 is an explanatory diagram of write processing by the virtual tape device;

FIG. 3A to 3E are an explanatory diagram of a management table;

FIG. 4 is an explanatory diagram of read processing by the virtual tape device;

FIG. 5 is a flow diagram of reception processing of backup data;

FIG. 6 is a flow diagram of save processing;

FIG. 7 is a first overview diagram illustrating an operation of the virtual tape device; and

FIG. 8 is a second overview diagram illustrating another operation of the virtual tape device.

### DESCRIPTION OF THE PREFERRED EMBODIMENTS

### Embodiment 1

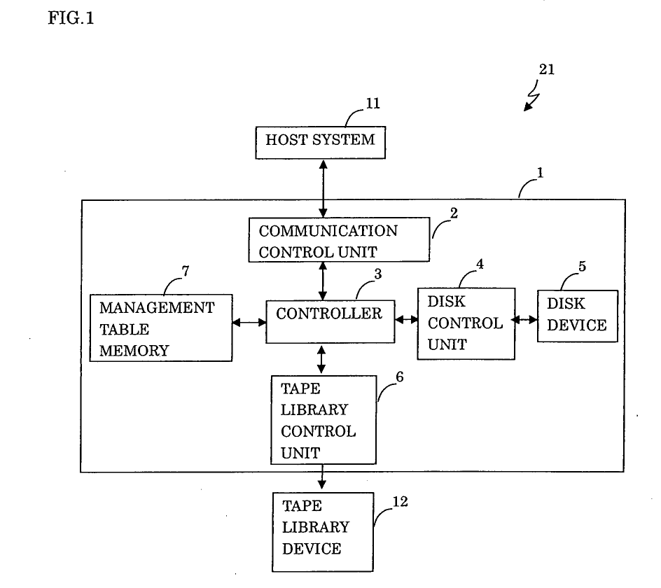

FIG. 1 shows a configuration diagram of a virtual tape device.

A computer system 21 includes a host system 11 connected to a virtual tape device 1, the virtual tape device 1, and a tape library device 12. The virtual tape device 1 includes a communication control unit 2, a controller 3, a disk control unit 4, a disk device 5, a tape library control unit 6, and a management table memory 7. The communication control unit 2 controls the communication of the controller 3 with the host system 11. The controller 3 performs processing in accordance with a command sent from the host system 11. In accordance with the processing, control of the data transfer between the host system 11 and the disk device 5, control of the data writing from the disk device 5 to the tape library device 12, and control of the data restoring from the tape library device 12 to the disk device 5 are performed. Further, a management table is managed.

Command processing will now be described. Upon receipt of a mount control sent from the host system 11, the controller 3 acquires a logical volume name, and selects a corresponding logical volume by referring to the management table of the management table memory 7. Then, if the data of the corresponding logical volume has been saved in the tape library device 12, and if the data has been deleted from the disk device 5, the controller 3 restores the data from the tape library device 12. A logical volume represents a logical area in the disk device 5 for storing therein a virtual tape volume, which corresponds to one magnetic tape. Upon receipt of a write command, the controller 3 writes data on the logical volume selected in accordance with the mount command. Meanwhile, upon receipt of a read command, the controller 3 reads the data of the selected logical volume. Further, upon receipt of an unload command, the controller 3 cancels the selection of the selected logical volume.

The disk control unit 4 controls the communication of the controller 3 with the disk device 5. The disk device 5 is a RAID device including a plurality of magnetic disk devices, for example, and is used as a tape volume cache for storing tape volumes. The tape volume cache includes a plurality of logical volume groups, each of which includes a plurality of logical volumes. A logical volume group that stores backup data is defined to include a remove attribute. The data of logical volumes registered in a group having the remove attribute is saved in a back-end system and immediately thereafter deleted from the tape volume cache. The tape library control unit 6 controls the communication of the controller 3 with the tape library device 12. The management table memory 7 stores the management table showing the correspondence between the disk device 5 and the tape library device 12.

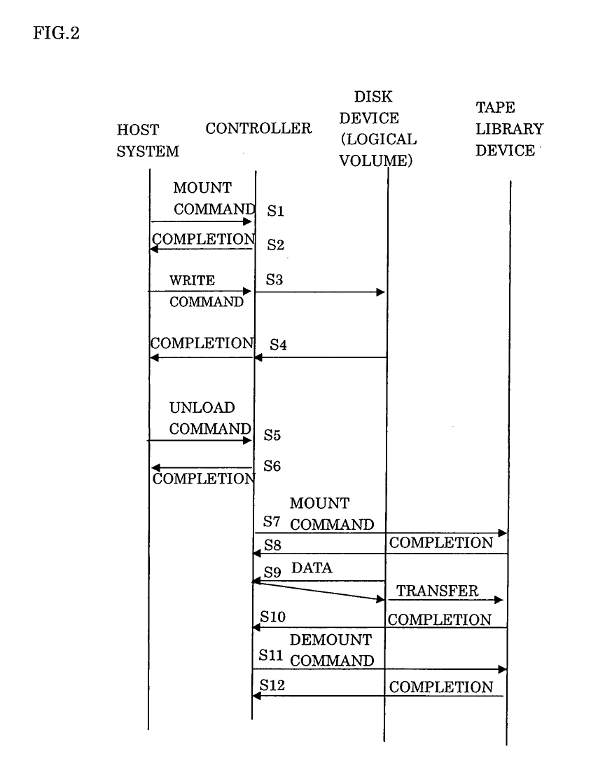

FIG. 2 shows an explanatory diagram of write processing by the virtual tape device 1. Upon start of processing for backing up backup data of the host system 11 in the tape library device 12, the host system 11 first issues a mount command to one of magnetic tapes stored in the tape library device 12. Then, the controller 3 of the virtual tape device 1 receives the mount command (Step S1).

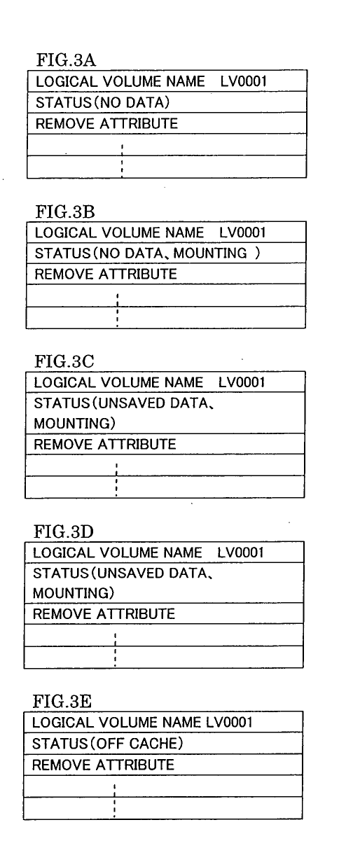

FIG. 3 shows an explanatory diagram of the management table. In the initial state of the management table, the management table is registered with a logical volume name LV0001, a “no data” status, and the remove attribute, for example (see FIG. 3A). Upon receipt of the mount command sent from the host system 11, the controller 3 acquires the logical volume name LV0001, for example. Then, with reference to the management table of the management table memory 7, the controller 3 selects a logical volume corresponding to the acquired information of the logical volume name LV0001, and the status is changed to “no data, mounting” (see FIG. 3B). Upon completion of the selection, the controller 3 returns a mount completion notice to the host system 11 (Step S2). Thereafter, in the case of receipt of a write command to the logical volume LV0001, the controller 3 writes data on the logical volume LV0001 (Step S3). In this case, the status in the management table is changed to “unsaved data exists, mounting” after the execution of the write command (see FIG. 3C). Upon completion of the data writing, the controller 3 sends a completion notice to the host system 11 (Step S4). Further, upon completion of the data writing, the host system 11 outputs an unload command to the controller 3. Then, the controller 3 receives the unload command (Step S5), and sends a completion notice to the host system 11 in response to the unload command (Step S6). In this case, the “mounting” status in the management table is cleared (see FIG. 3D). The logical volume LV0001 has the remove attribute. Therefore, after the above step, the data is saved from the virtual tape device 1 to the tape library device 12. The controller 3 selects, for example, a tape name LV0001 in the tape library device 12 corresponding to the logical volume LV0001, in which the data to be saved should be stored. Then, the controller 3 sends a mount command to the tape library device 12 (Step S7). Upon receipt of a mount completion notice sent from the tape library device 12 (Step S8), the controller 3 reads data from the corresponding logical volume LV0001 of the disk device 5, and transfers the data to the tape library device 12 (Step S9). Then, upon receipt of a write completion notice from the tape library device 12 notifying the completion of writing of the data (Step S10), the controller 3 outputs a demount command (Step S11). When the controller 3 receives a completion notice from the tape library device 12 in response to the demount command (Step S12), the save processing is completed. Then, the data area of the logical volume LV0001 is cleared from the disk device 5. Thus, the status in the management table is changed to “off cache” (see FIG. 3E).

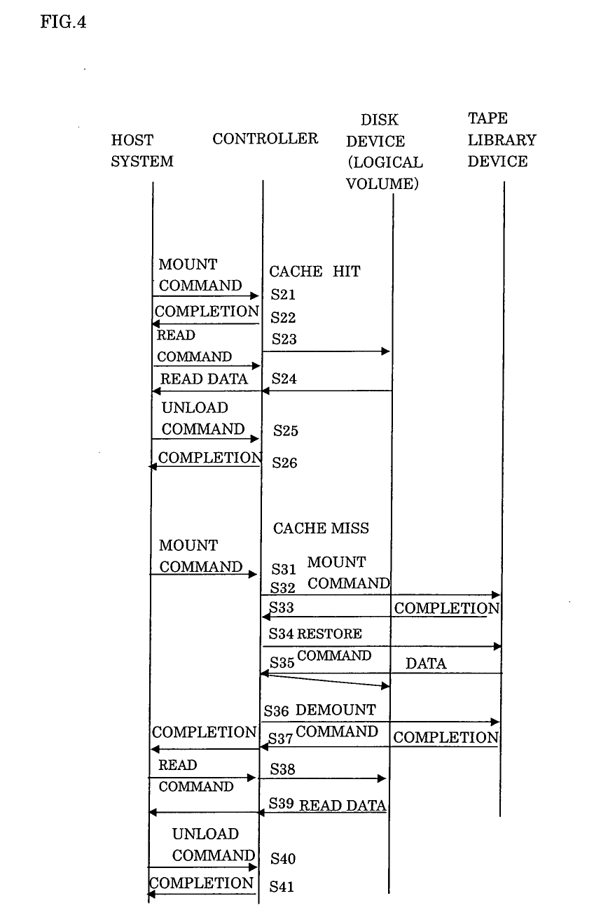

FIG. 4 shows an explanatory diagram of read processing by the virtual tape device 1. The controller 3 of the virtual tape device 1 receives a mount command (Step S21). Then, upon acquisition of a logical volume name in accordance with the mount command, the controller 3 selects a corresponding logical volume in the disk device 5 by referring to the management table. If the status of the selected logical volume is “unsaved data exists,” the state is considered as cache hit. Upon completion of the selection, the controller 3 returns a completion notice to the host system 11 in response to the mount command (Step S22). Then, upon receipt of a read command (Step S23), the controller 3 reads data from the data storage area of the selected logical volume. The controller 3 then sends the read data to the host system 11 (Step S24). Upon receipt of an unload command sent from the host system 11 (Step S25), the controller 3 returns a completion notice to the host system 11 (Step S26).

Meanwhile, when the controller 3 receives a mount command (Step S31), if the corresponding logical volume has been saved, and if the status is “off cache,” which represents the state in which the data has been deleted, the state is considered as cache miss. Thus, the controller 3 selects the tape library device 12, which stores the data to be read, and sends a mount command to the tape library device 12 (Step S32). Then, upon receipt of a mount completion command from the tape library device 12 (Step S33), the controller 3 sends a restore command (Step S34). Further, upon receipt of the data from the tape library device 12 in response to the restore command (Step S35), the controller 3 stores the data in the disk device 5. Then, the controller 3 sends a demount command to the tape library device 12 (Step S36). When controller 3 receives a demount completion notice from the tape library device 12, the restore processing is completed. Then, the controller 3 sends a completion notice to the host system 11 in response to the mount command (Step S37). Subsequently, upon receipt of a read command sent from the host system 11 (Step S38), the controller 3 reads the data from the data storage area of the logical volume. Then, the controller 3 sends the read data to the host system 11 (Step S39). Further, when the controller 3 receives from the host system 11 an unload command to the logical volume (Step S40), the controller 3 sends a completion notice to the host system 11 (Step S41), and the read processing is completed. In the backup operation, however, the controller 3 does not usually receive the read command. This is because the backup data is not reused except for the case of a system failure. Meanwhile, in the batch operation, there are cases in which the controller 3 receives the read command.

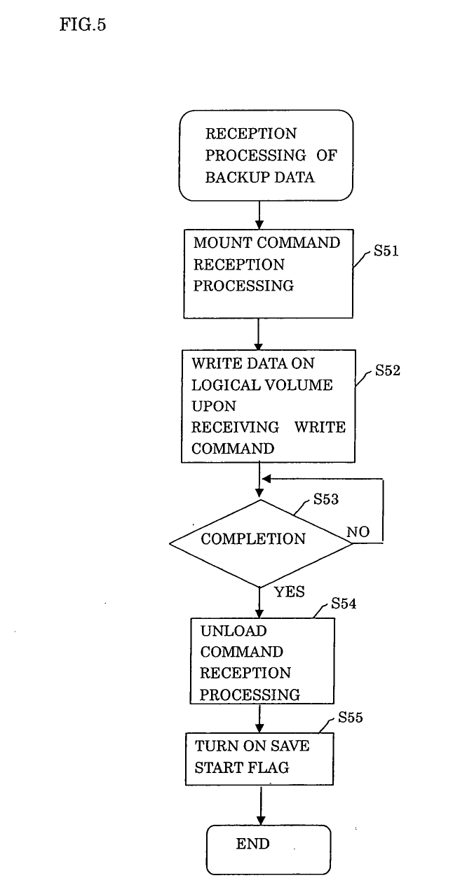

FIG. 5 shows a flow diagram of reception processing of the backup data. The controller 3 performs reception processing in response to a mount command sent from the host system 11 (Step S51). If there is no free space in the area of the disk device 5, the controller 3 responds to the host system 11 with a notice that the reception is unacceptable. If there is free space in the area, the controller 3 selects a corresponding logical volume and thereafter returns a completion notice to the host system 11. Then, the controller 3 receives a write command and writes data on the selected logical volume (Step S52). Thereafter, whether the writing has been completed is checked (Step S53). If the writing has not been completed, the processing returns to Step S53. If the writing has been completed, unload command reception processing is performed (Step S54). Then, to save the data in the tape library device 12, a save start flag is turned on (Step S55).

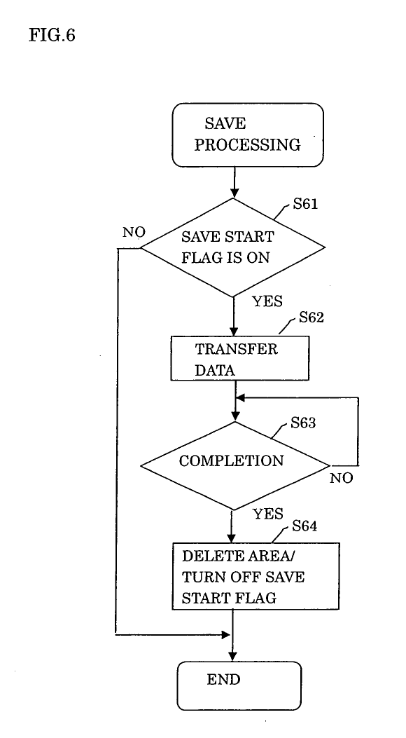

FIG. 6 shows a flow diagram of save processing. Description of mount command processing and demount command processing will be omitted. Whether the save start flag is on is checked (Step S61). If the save start flag is off, the processing is completed. If the save start flag is on, the controller 3 transfers the data stored in the logical volume to the tape library device 12 (Step S62). Then, whether the data of the logical volume has been saved is checked (Step S63). If the data has not been saved, the processing returns to Step S63. If the data has been saved, the corresponding area in the disk device 5 is deleted. Further, the save start flag is turned off (Step S64). Thus, even during the save processing, if there is free space in the disk device 5, the controller 3 can receive a write command sent from the host system 11. In the present configuration, therefore, the reception processing of the write command and the save processing are performed in parallel.

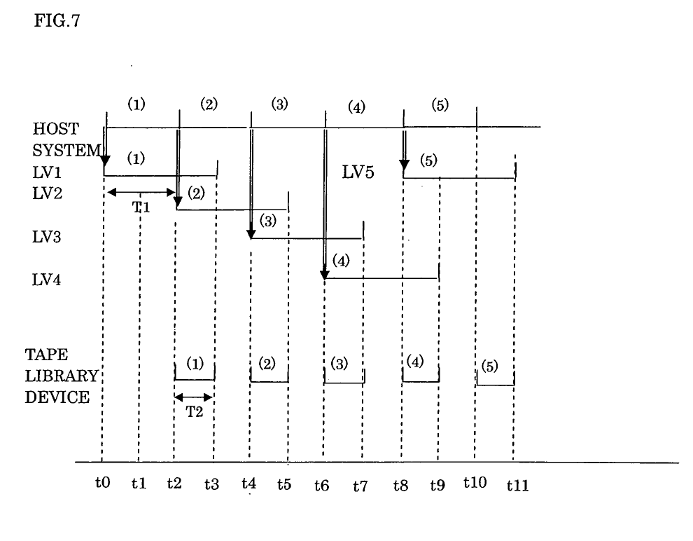

FIG. 7 shows a first overview diagram illustrating an operation of the virtual tape device 1. This is an example in which data of the batch operation and data of the backup operation are stored in the disk device 5. Conventionally, in this case, if the data of the backup operation is increased and thus the area for storing the backup data runs out, the least recently accessed portion of the data stored in the disk device 5 is saved. It is highly possible that the virtual tape used in the batch operation is frequently accessed. Thus, if the data of the virtual tape has been saved, the required processing includes the steps of reading the data from the tape library device 12 in response to a read command sent from the host system 11, developing the data on the virtual tape device 1, and then transferring the data to the host system 11. As a result, the processing takes a long time. To avoid such a situation, a plurality of logical volumes on the virtual tape device 1 are defined to form a logical volume group for the backup processing operation and provided with the remove attribute. The backup data is not reused except for the case of a system failure. In the present configuration, therefore, when the controller 3 has received from the host system 11 data addressed to a logical volume of the logical volume group for the backup operation, the controller 3 immediately transfers the data to the tape library device 12. Accordingly, it is possible to reduce the saving of the batch operation data due to the increase in frequency of the backup operation.

The operation of the backup operation by the virtual tape device 1 will now be described. Description will be first made of a case in which a time T1 is longer than a time T2. The time T1 represents a time taken from the reception of a mount command sent from the host system 11 until the completion of the write processing of data to the disk device 5 and the unload command processing, while the time T2 represents a time taken for the saving of the data from the virtual tape device 1 to the tape library device 12. The time T2 corresponds to a time taken from the reception of the mount command issued to store data in the tape library device 12 until the reception of the completion notice of the demount command. In the present example, the relationship T1>T2 is established. It is assumed that the logical volume group of the disk device 5 for the backup operation has been defined to include LV1 to LV4. In the present example, host data portions (1) to (4) are sequentially stored in the LV1 to the LV4.

The data portions (1), (2), (3), and (4) sent from the host system 11 are first received. The received data portions are sequentially stored in the group of the logical volumes LV1 to LV4. Then, the stored data portions are compressed and sequentially stored in the tape library device 12. As for the data portion (1), the reception of the data portion from the host system 11 is started at a time t0, and the storage of the data portion in the LV1 is completed at a time t2. Then, the transfer of the data portion to the tape library device 12 is started at the time t2. When the transfer of the data portion to the tape library device 12 is completed at a time t3, the storage area of the LV1 is cleared by the controller 3 at the time t3. The status in the management table of the logical volume LV1 is set as “off cache,” and the area is released. As for the data portion (2), the reception of the data portion from the host system 11 is started at the time t2, and the storage of the data portion in the LV2 is completed at a time t4. Then, the transfer of the data portion to the tape library device 12 is started at the time t4. When the transfer of the data portion to the tape library device 12 is completed at a time t5, the storage area of the LV2 is cleared by the controller 3 at the time t5. The status in the management table of the logical volume LV2 is set as “off cache,” and the area is released. As for the data portion (3), the reception of the data portion from the host system 11 is started at the time t4, and the storage of the data portion in the LV3 is completed at a time t6. Then, the transfer of the data portion to the tape library device 12 is started at the time t6. When the transfer of the data portion to the tape library device 12 is completed at a time t7, the storage area of the LV3 is cleared by the controller 3 at the time t7. The status in the management table of the logical volume LV3 is set as “off cache,” and the area is released. As for the data portion (4), the reception of the data portion from the host system 11 is started at the time t6, and the storing of the data portion in the LV4 is completed at a time t8. Then, the transfer of the data portion to the tape library device 12 is started at the time t8. When the transfer of the data portion to the tape library device 12 is completed at a time t9, the storage area of the LV4 is cleared by the controller 3 at the time t9. The status in the management table of the logical volume LV4 is set as “off cache,” and the area is released.

It is now assumed that the logical volume group of the disk device 5 for the backup operation has been defined to include an increased number of logical volumes LV1 to LV5. In this case, when a data portion is stored in the LV5, the disk area of the LV1 to the LV3 has already been cleared. Therefore, the data portion can be stored in the added logical volume LV5, without making the least recently accessed data portion on the disk device 5 removed therefrom. Thus, in the case in which the relationship T1>T2 is established, the backup operation can be performed even if the number of the logical volumes is increased to be more than the LV5. This is because the substantive data storage area does not increase to exceed the area occupied by the LV1 to the LV4. Accordingly, an increase in frequency of the backup operation will not cause the data of the batch operation to be saved. This is because the data of the logical volumes chached in the disk device 5 is immediately removed. Thus, the increase in frequency of the backup operation does not affect the batch operation. That is, even if the backup operation is increased in frequency, the area in the disk device 5 is cleared due to the immediate removal of the data. Therefore, even if the logical volume group for the backup operation has been defined to have an increased capacity, the processing can be performed within a predetermined area without increasing the data storage area.

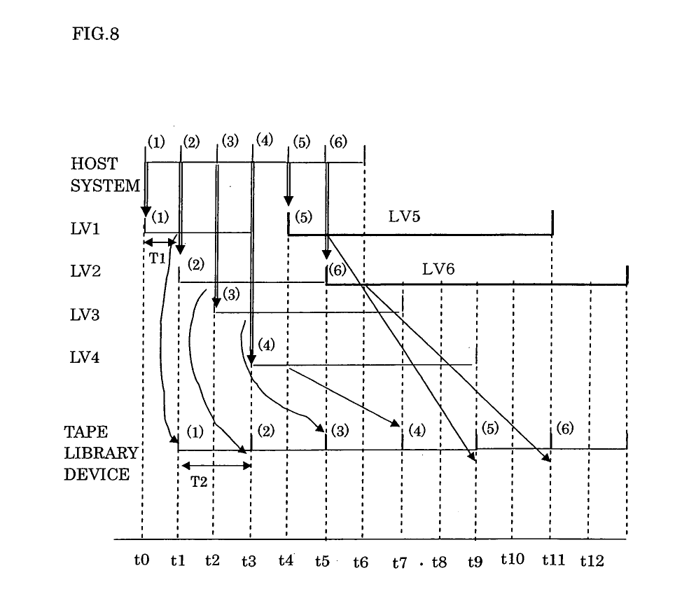

FIG. 8 shows a second overview diagram illustrating another operation of the virtual tape device 1. Description will be made of a case in which a time T1 is shorter than a time T2. The time T1 represents a time taken from the reception of a mount command sent from the host system 11 until the completion of the write processing of data to the disk device 5 and the unload command processing, and the time T2 represents a time taken for the saving of the data from the virtual tape device 1 to tape library device 12. In the present example, the relationship T1<T2 is established. It is assumed that the logical volume group of the disk device 5 for the backup operation has been defined to include LV1 to LV4. In the present example, host data portions (1) to (4) are sequentially stored in the LV1 to the LV4.

The data portions (1), (2), (3), and (4) sent from the host system 11 are first received. The received data portions are sequentially stored in the group of the logical volumes LV1 to LV4. Then, the stored data portions are sequentially stored in the tape library device 12. As for the data portion (1), the reception of the data portion from the host system 11 is started at a time t0. Then, when the storage of the data portion in the LV1 is completed at a time t1, the transfer of the data portion to the tape library device 12 is started at the time t1. When the transfer of the data portion to the tape library device 12 is completed at a time t3, the storage area of the LV1 is cleared by the controller 3 at the time t3. The status in the management table of the logical volume LV1 is set as “off cache,” and the area is released. In a similar manner, the data portions (2) to (4) are sequentially saved.

It is now assumed that the logical volume group of the disk device 5 for the backup operation has been defined to include an increased number of logical volumes LV1 to LV6. It is then assumed that a tape data portion (5) sent from the host system 11 is received at a time t4. The logical volume LV1 has been released at the time t3. Thus, after the reception of the data portion (5), the LV5 is written on the data area released by the LV1. Then, it is assumed that a tape data portion (6) sent from the host system 11 is received at a time t5. The logical volume LV2 has been released at the time t5. Thus, after the reception of the data portion (6), the LV6 is written on the area released by the LV2. Thus, in the case in which the relationship T1<T2 is established, the backup operation can be performed even if the number of the logical volumes is increased, as long as the increased number does not exceed a predetermined value (up to the LV6 in the present example), which is determined by the difference in processing speed. This is because, within this range, the substantive data area does not increase to exceed the area occupied by the LV1 to the LV4. Accordingly, within the range of from the LV1 to the LV6, an increase in frequency of the backup operation will not cause the data of the batch operation to be saved. Further, even if the logical volume group for the backup operation has been defined to exceed the range of from the LV1 to the LV6, the reception of an exceeded data portion sent from the host system 11 is suspended until the area capable of accepting the reception is released. Accordingly, data stored in another area for the batch operation or the like is prevented from being removed therefrom.

As described above, a tape data cached in the disk device 5 is immediately removed. Thus, even if the frequency of the backup operation is increased, the influence of the increase on the batch operation is reduced. That is, even if the frequency of the backup operation is increased, the area in the disk device 5 is cleared by the immediate removal of the tape data. Therefore, the processing can be performed even if the logical volume group for the backup operation has been defined to have an increased capacity.

Accordingly, the restore processing from the tape library device 12 can be reduced.

What is claimed is:

1. A virtual tape device interposed between a host system and a tape library device to store data transmitted and received between the host system and the tape library device as a virtual tape volume, the virtual tape device comprising:
a storage device for storing the data sent from the host system as the virtual tape volume;
means for starting to save the data in the tape library device upon completion of the storage of the data as the virtual tape volume; and
means for deleting from the storage device the virtual tape volume corresponding to the saving upon completion of the saving.

2. The virtual tape device according to claim 1,
wherein the virtual tape volume is provided with a remove attribute, and
wherein only the virtual tape volume having the remove attribute starts to be saved.

3. The virtual tape device according to claim 1,
wherein backup data received from the host system is stored as the virtual tape volume and saved.

4. A data management method for a virtual tape device interposed between a host system and a tape library device to store data transmitted and received between the host system and the tape library device as a virtual tape volume, the method comprising:
storing the data sent from the host system as the virtual tape volume;
starting to save the data in the tape library device upon completion of the storage of the data as the virtual tape volume; and
deleting the virtual tape volume corresponding to the saving upon completion of the saving.

5. The data management method for a virtual tape device according to claim 4,
wherein, in the save starting step, only the virtual tape volume having a remove attribute starts to be saved.

6. The data management method for a virtual tape device according to claim 4,
wherein, in the save starting step, the virtual tape volume including backup data received from the host system is saved.
